(19) United States
(12) Patent Application Publication
(10) Pub. No.: US 2002/0068473 A1
(43) Pub. Date: Jun. 6, 2002

(54) High-voltage electrical connecting device

(76) Inventors: Hans W.A. Jedlitschka, Chatillon (FR); Gilbert Dubois, Clamart (FR)

Correspondence Address: Jay L. Chaskin, General Electric Company, 3135 Easton Turnpike, Faifield, CT, 06431-0001, US

(21) Appl. No.: 09/991,282

(22) Filed: Nov. 14, 2001

(30) Foreign Application Priority Data
Dec. 1, 2000 (FR) 0015594

(51) Int. Cl. H01R 4/38

(52) U.S. Cl. 439/320

(57) ABSTRACT

Electrical connecting device comprising a female element and a male element intended to be inserted in the female element. In order to fit a reduced-size male element in a standard-size female element, an adaptor element, presenting shapes and dimensions adapted to the interior shapes and dimensions of the standard-size female element and to the exterior shapes and dimensions of the reduced-size male element, is inserted between the male and female elements. Adapting contacts cooperate with the contacts of the male and female elements. Fastening is carried out by means of a bearing ring fitted to the adaptor element and to the reduced-size element and by means of a screw locking ring.

### CROSS REFERENCE TO RELATED APPLICATIONS

This application claims the benefit of a priority under 35 USC 119 to French Patent Application No. 0015594 filed Dec. 1, 2000, the entire contents of which are incorporated by reference.

### BACKGROUND OF THE INVENTION

The present invention is directed to an electrical connecting device for a high-voltage apparatus, comprising two separable insulating elements, each containing at least one electrical contact. One electrical contact is a female element comprising means for attachment to means for receiving on a high-voltage apparatus, and another electrical contact is a male element comprising means for a connecting to a high-voltage cable. The male element is intended to be inserted into the female element and to be fastened to the means for receiving to establish electrical continuity between the contacts of the two elements.

Such high-voltage connecting devices are used, notably, for the power supply of medical imaging apparatuses, for example, an X-ray tube apparatus. In particular, the apparatus to be supplied is surrounded by a grounded metal casing to which the female element of the connecting device is fastened, while the male element comprises the end of a high-voltage cable coming from a high-voltage generator.

Up to now, these connecting devices used in the medical field have been of “standard” size and come under a so-called “Federal Standard.”

A new type of high-voltage connecting device has been developed because of progress made in insulating materials and high-frequency converters. This new type of connecting device of “reduced” size will differ from the standard-size connecting device, in particular, by a reduction of the lengths and diameters of the female elements and male elements. An apparatus equipped with connecting devices of this type, whether involving high-voltage generators or imaging apparatus fed by these generators, will then be systematically equipped with reduced-size connecting devices. It will frequently happen that only one of these two apparatus will be replaced by a new apparatus equipped with the reduced-size connecting device, while the other apparatus is still equipped with a standard-size connecting device will remain operating.

To avoid having to change the standard-size connecting element and replace it with a reduced-size connecting element, the use of so-called hybrid cables may be used. The hybrid cables comprise a connecting element of reduced size type at one end and a connecting element of the other type at the other end. To be able to deal with all these possibilities, it will be necessary to have at least two types of hybrid cables available, one with a standard-size female connecting element and a reduced-size male connecting element, and the other with a reduced-size female connecting element and a standard-size male connecting element. This will entail a high cost.

### BRIEF DESCRIPTION OF THE INVENTION

The present invention is an adaptor system to connect high-voltage apparatuses together simply and rapidly, one designed to use a standard-size connecting device and the other a reduced-size connecting device, without having to resort to such hybrid cables.

The electrical connecting device according to an embodiment for a high-voltage apparatus comprises two separable insulating elements, each containing at least one electrical contact. One electrical contact is a female element comprising means for attachment to means for receiving on a high-voltage apparatus, and a male element another electrical contact is comprising a connecting end of a high-voltage cable. The male electrical contact is intended to be inserted into the female element and to be fastened to means for receiving to establish of electrical continuity between the contacts of the two elements. The device includes, with a view to the fitting of a reduced-size male element to a standard-size female element, means for adapting shape and contact comprising an insulator having an outer configuration matching the inner configuration of the standard-size female element, an inner configuration matching the outer configuration of the reduced-size male element, and at least one intermediate contact which is incorporated in the insulator and which, when the reduced-size male element is inserted in the standard-size female element, the means for adapting shape and contact being intercalated between them, establishes electrical continuity between the contacts of the two elements. The device further may include means for fastening shaped to enable the reduced-size male element and means for adapting shape and contact to be fastened to means for standard-size receiving provided on the high-voltage apparatus.

The means for standard-size receiving may comprise a cylindrical socket with interior threading and an interior annular bearing, the means for standard-size fastening comprising a bearing ring cooperating with the standard-size male element and a locking ring with exterior threading screwed into the socket in order to tighten the standard-size male element with the bearing ring against the bearing. The means for fastening comprises a bearing ring shaped to cooperate with the reduced-size male element and to enable the latter to be tightened by means for locking of the same locking ring in the means for standard-size receiving.

### BRIEF DESCRIPTION OF THE DRAWINGS

Referring to the attached drawings, an embodiment of a connecting device is described in greater detail as follows:

FIG. 1 is an axial section of a standard-size high-voltage connecting device;

FIG. 2 is a matching section of a reduced-size high-voltage connecting device; and

FIG. 3 is a matching section of the fitting of a reduced-size male connecting element to a standard-size female connecting element.

### DETAILED DESCRIPTION OF THE INVENTION

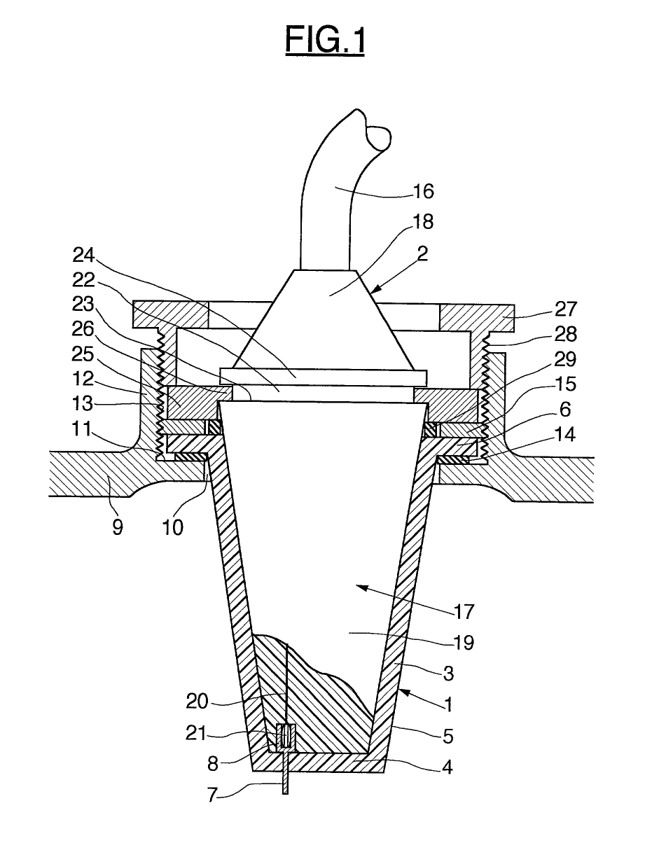

According to FIG. 1, a standard-size high-voltage electrical connecting device of “Federal Standard” type, as used, for example, in medical imaging, comprises a female connecting element 1 and a male connecting element 2.

The female connecting element 1 forms a receptacle comprising an intermediate truncated cone-shaped hollow insulating casing 3 of, for example, rigid plastic. The truncated cone-shaped casing 3, closed at its narrow base and open at its wide base, comprises a bottom wall 4, a side wall 5 and, at its open end, an annular outer edge 6. The bottom wall 4 is crossed by at least one electrical conductor 7 which ends inside the casing 3 in a contact 8, for example, a female, and which is joined outside the casing 3 to the apparatus equipped with the female connecting element 1.

This apparatus, not represented, includes a metal casing with a wall 9 containing, in order to receive the connecting device, a hole 10 surrounded outside the wall 9 by a flat annular bearing surface 11 and a cylindrical socket 12 provided with an interior threading 13.

In order to fasten the female connecting element 1 to the wall 9, a seal 14 is placed on the bearing surface 11, the element 1 is engaged from outside the wall 9 in the hole 10, with the bottom wall 4 in front, and its edge 6 is locked on the surface 11, with compression of the seal 14, by screwing a ring 15 with exterior threading in the socket 12.

The male connecting element 2 forming a plug, which is integral with the end of a cable 16, comprises an insulator 17, made of elastically deformable plastic, for example, of biconical general shape, with a truncated cone-shaped back part 18, beside the cable 16, and a truncated cone-shaped front part 19, the outer shape and dimensions of which match the inner shape and dimensions of the casing 3 of the female connecting element 1. The body 17 is crossed by at least one conductor 20 joined to the cable 16 and ending at the free end of the insulator 17 in a male contact 21 complementing the female contact 8. The insulator 17 is configured, in the area of junction of two truncated cone-shaped parts 18 and 19, with an annular groove 22 delimited beside part 19 by a shoulder 23 and beside part 18 by an outer annular edge 24.

Fastening of the male connecting element 2, after insertion of the latter in the female connecting element 1, is carried out by means of a slotted bearing ring 25 presenting an interior edge 26 capable of being engaged in the groove 22 of element 2, before insertion of the latter in element 1, and by means of a locking ring 27 with a T-section, presenting on its part matching the vertical member of the T-section, an exterior threading 28 to which the ring 27 can be screwed into the socket 12 of the wall 9 in order to come to bear on the ring 25 and tighten the latter on ring 15, which locks the male connecting element 2 in the female connecting element 1, a seal 29 situated inside ring 15 being simultaneously compressed between the edge 6 and ring 25 in order to ensure tightness between the two elements 1 and 2.

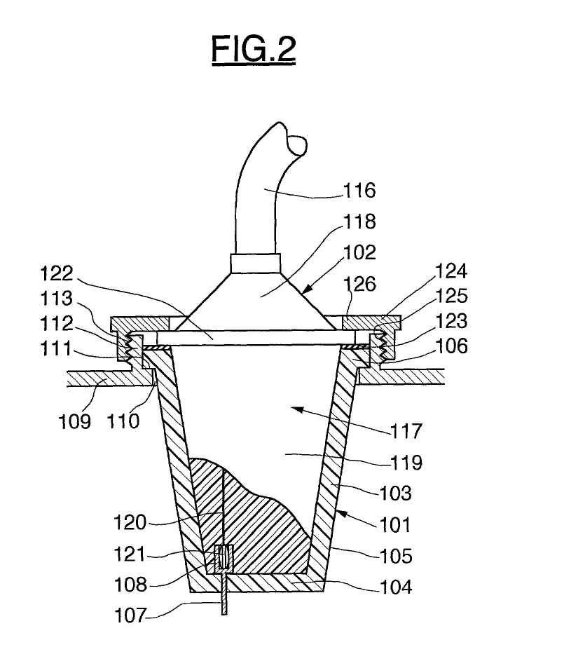

FIG. 2 represents a reduced-size connecting device comprising similar to the standard-size device of FIG. 1, of a female connecting element 101 and a male connecting element 102.

The female connecting element 101 or receptacle comprises an interior truncated cone-shaped hollow insulating casing 103 of, for example, rigid plastic, for example, defined by a bottom wall 104 at its small-diameter closed end and by a side wall 105 open at its large-diameter end, where it contains an annular outer edge 106. The bottom wall 104 is crossed by at least one electrical conductor 107 joined inside the casing 103 to a contact 108, a female contact, for example, and outside the casing 103 to the electrical apparatus to be fed.

This apparatus contains a grounded metal casing, the wall 109 of which contains, in order to receive the reduced-size connecting device, a through hole 110 surrounded outside the wall 109 by an annular bearing surface 111, which is in turn surrounded by an exterior cylindrical socket 112 provided with an exterior threading 113.

The male connecting element 102 or plug, placed at the end of a cable 116, comprises a biconical insulator 117 of elastically deformable plastic, for example, containing a truncated cone-shaped back part 118 and a truncated cone-shaped front part 119.

The insulator 117 is crossed by at least one conductor 120 which, joined to the cable 116, contains at its free end a male contact 121 complementing the female contact 108. In the area of junction of the two parts 118 and 119, the insulator 117 contains an exterior annular edge 122.

The female connecting element 101 is engaged from the outside of the wall 109, with the bottom wall 104 turned forward, in the hole 110 of wall 109, so that its edge 106 comes to bear on the bearing surface 111. A seal 123 is placed on the edge 106 and the male element 102 is then inserted in the female element 101, so that its edge 122 comes to bear on the seal 123. Fastening is carried out by means of a nut 124 having a T-section with an interior threading 125 on the part matching the vertical member of the T-section. On screwing of the nut 124 on the socket 112, the interior annular edge 126 of the nut tightens the exterior edge 122 of the male connecting element 102 against the seal 123, ensuring tightening of the two elements 101 and 102 to each other and their fastening to the wall.

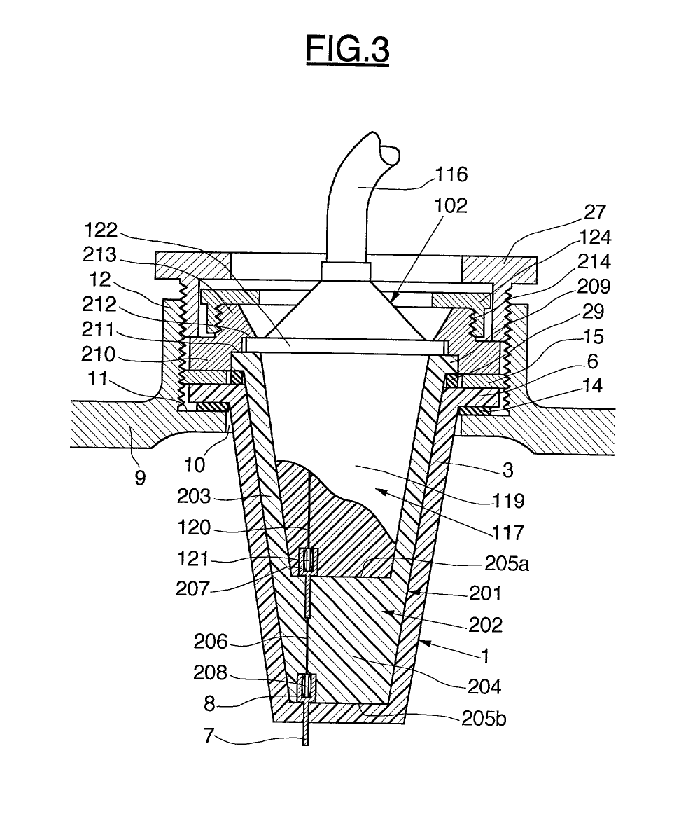

FIG. 3 illustrates an embodiment of the invention to enable a reduced-size male connecting element 102, at the end of a cable 116, to cooperate with a standard-size female element 1.

The female element 1 is fastened, as in FIG. 1, to the wall 9 of a casing, containing a through hole 10 surrounded by an outer bearing surface 11 and a socket 12, the outer edge 6 of the casing 3 of the element 1 being tightened by means of a seal 14 against the bearing surface 11 with the aid of a threaded ring 15.

In order to fit a reduced-size male connecting element 102 to the standard-size female connecting element 1, an adaptor element 201 is provided, comprising a hollow insulator 202 of, for example, elastic plastic the outer shape of which matches the shape of the front part 19 of the insulator 17 of the standard-size male connecting element 2 and, therefore, the inner shape of the casing 3 of the standard-size female connecting element 1, while its inner shape matches the shape of the front part 119 of the insulator 117 of the reduced-size male connecting element 102. The insulator 202 of the adaptor element 201 therefore presents, internally and externally, truncated cone shapes and contains a thin truncated cone-shaped side wall 203 and a thicker bottom wall 204 situated between the interior bottom surface 205a and an exterior bottom surface 205b. The adaptor element 201 contains, in that bottom wall 204, at least one electric conductor 206 extending from a female contact 207 situated in the area of the interior bottom surface 205a to a male contact 208 situated in the area of the outer bottom surface 205b.

At its large-diameter open end, situated opposite the bottom wall 204, the insulator 202 of the adaptor element 201 presents an outer annular edge 209.

In order to join the reduced-size male connecting element 102 to the standard-size female connecting element 1, fastened by means of ring 15 in the socket 12 of wall 9, the male connecting element 102 is inserted in the adaptor element 201, so that its male contact 121 is inserted in the female contract 207 of the adaptor element 201. The two elements 102, 202 thus joined are then inserted in the standard-size female connecting element 1, so that the male contact 208 of the adaptor element 201 is inserted in the female contact 8 of the female connecting element 1, which establishes electrical continuity between the electrical conductor 120 of the reduced-size male connecting element 102 and the conductor 7 coming out of the standard-size female connecting element 1.

For the fastening of element 102, a bearing ring 210 similar to ring 25 is used, with just the difference that it is not slotted and presents an interior profile with a shoulder 211 fitted to the outer edge 209 of the adaptor element 201 and an edge 212 fitted to the edge 122 of the reduced-size male connecting element 102, in order to be able to lock those two edges on its tightening against ring 15 by means of the threaded locking ring 27, by screwing of the latter into the socket 12 of wall 9. The seal 29 is intercalated here inside ring 15 between the edge 6 of the standard-size female connecting element 1 and the edge 209 of the adaptor element 201.

The bearing ring 210 contains, furthermore, opposite its tightening edge on ring 15, a cylindrical socket 213 presenting an exterior threading 214 making it possible to screw there the nut 126 used to fasten the reduced-size male connecting element 102, when the latter cooperates with a reduced-size female connecting element 101, according to FIG. 2, but which has no function here.

It is to be noted that this embodiment, as represented and described, has been presented only by way of illustration and without limitation, and that numerous modifications and variants are possible within the scope of the invention.

Thus, although only one contact is visible in the drawings, it is possible to provide several contacts on the male element and female element and a corresponding number of contacts on the adaptor element.

Variants are also conceivable, as far as the shapes and dimensions of the male and female elements are concerned, the adaptor element being designed in all cases so that its shapes are adapted internally to those of the reduced-size male element and externally to those of the standard-size female element. As described herein, either the means for connecting or the means for attachment may be a male or female connecting element. As described herein either means for connecting or the means for attachment may be of a reduced-size or of a standard-size.

Various modifications in structure and/or steps and/or function may be made by one skilled in the art without departing from the scope and extent of the invention as recited in the claims.

What is claimed is:

1. An electrical connecting device comprising:
two separable insulating elements, each having at least one electrical contact a first at least one element comprising means for attachment to receiving means a second and at least one and an male having at a connecting end a high-voltage cable to be connected with in the first element and to be fastened to the means for receiving to establish of electrical continuity between the contacts of the two elements, wherein the first element has a standard-size and the second element has a reduced-size;
means for adapting shape and contact comprising an insulator having an outer configuration matching the inner configuration of the standard-size element, an inner configuration matching the outer configuration of the reduced-size element, and at least one intermediate contact incorporated in insulator in order to establish electrical continuity between the contacts of said two elements, and
means for fastening shaped to enable the reduced-size element and means for adapting shape and contact to be fastened to the means for receiving.

2. The device according to claim 1, wherein:
the means for receiving contains a cylindrical socket with interior threading and an interior annular bearing;
the means for fastening comprises a standard-size bearing ring cooperating with the standard-size element and a locking ring with exterior threading screwed into the socket in order to lock the standard-size element with the bearing ring against the bearing;
the means for fastening comprises a bearing ring shaped to cooperate with the reduced-size element and to enable the reduced-size element to be locked by the same locking ring in the means for receiving.

3. A device according to claim 1, wherein the standard-size element has an insulator with an interior truncated cone shape;
the reduced-size element has an insulator with an exterior truncated cone shape; and
the means for adapting shape and contact adaptor has a hollow insulator with an exterior truncated cone shape and an interior truncated cone shape adapted to the standard-size element and the reduced-size element, respectively.

4. A device according to claim 2, wherein the standard-size element has an insulator with an interior truncated cone shape;
the reduced-size element has an insulator with an exterior truncated cone shape; and
the means for adapting shape and contact adaptor has a hollow insulator with an exterior truncated cone shape and an interior truncated cone shape adapted to the standard-size element and the reduced-size element, respectively.

5. The device according to claim 3, wherein the insulator contains contacts cooperating with the contacts of the standard-size element and reduced-size male element upon the connection of the element with the element, the means for adapting shape and contact being intercalated between the elements.

6. The device according to claim 4, wherein the insulator contains contacts cooperating with the contacts of the standard-size element and reduced-size male element upon the connection of the element with the element, the means for adapting shape and contact being intercalated between the elements.

7. The device according to claim 2, wherein the truncated cone-shaped insulator of the reduced-size element has an outer edge at its large-diameter end;
the insulator of the means for adapting shape and contact has an outer edge at its large-diameter end; and
a bearing ring has two inside edges cooperating with the outer edges, respectively.

8. The device according to claim 7, wherein fastening of the standard-size element and the reduced-size element to the means for receiving comprises means locking; and
the bearing ring comprises a socket with exterior threading on which means for locking nut can be screwed.

9. The device according to claim 1 either the first element or the second element is a male element or a female element or vice versa.
